(19) United States
(12) Patent Application Publication
(10) Pub. No.: US 2012/0138771 A1
(43) Pub. Date: Jun. 7, 2012

(54) REFLECTING OPTICAL DETECTING DEVICE AND ELECTRONIC APPARATUS PROVIDED WITH THE SAME

(75) Inventors: WEN-CHIEH LI, NEW TAIPEI CITY (TW); MENG-KUN CHEN, NEW TAIPEI CITY (TW); MING-CHIEH TSOU, NEW TAIPEI CITY (TW); YUNG-SHENG SHEN, NEW TAIPEI CITY (TW); CHUN-HSIEN LIN, NEW TAIPEI CITY (TW)

(73) Assignee: LITE-ON SEMICONDUCTOR CORP., NEW TAIPEI CITY (TW)

(21) Appl. No.: 13/073,016

(22) Filed: Mar. 28, 2011

(30) Foreign Application Priority Data
Dec. 1, 2010 (CN) 201010576100.0

(51) Int. Cl. G01C 21/00

(52) U.S. Cl. 250/206.1

(57) ABSTRACT

A reflective optical detecting device is for detecting movement of an object in a predetermined area. The reflective optical detecting device includes a light emitting unit, at least two optical detectors, and a comparing unit. The light emitting unit is used for illuminating the predetermined area. The optical detectors are disposed at opposite sides of the light emitting unit, and each of the optical detectors is associated with a respective detection region within the predetermined area for generating an output signal in response to light reflected from the object and detected thereby. The comparing unit is coupled to the optical detectors for receiving the output signal from each of the optical detectors, and is operable to output a comparison result according to the output signal of each of the optical detectors. The comparison result is to be used for determining the movement of the object.

### CROSS-REFERENCE TO RELATED APPLICATION

This application claims priority of Chinese Application No. 201010576100.0, filed on Dec. 1, 2010.

### BACKGROUND OF THE INVENTION

1. Field of the Invention

The present invention relates to an optical detecting device, more particularly to a reflective optical detecting device.

2. Description of the Related Art

An electronic apparatus generally includes detecting device (also known as a pointing device) for detecting movement of an object, and a control unit operable to implement an operation according to the detected movement of the object.

U.S. Pat. No. 7,469,639 discloses a reflective optical encoder for detecting a movable component. The reflective optical encoder includes a code member having a plurality of reflectors thereon, a light source for illuminating an area of the code member that includes at least one of the reflectors, and a detector array. The code member and the detector array are moveable with respect to one another, and as the cede member is moved by the movable component (e.g., a user's finger) with respect to the detector array, the reflectors on the code member reflect light emitted by the light source to produce light spots that travel across the detector array. Then, a processing system is operable to determine the velocity and the direction of the motion between the code member and the detector array according to the data associated with the spots traveling across the detector array.

WO 2004/090709 discloses a pointing device to operate a portable electronic device using a finger. The pointing device includes a light emitting means for illuminating a subject (e.g., a finger), an image-acquisition area for taking an image of the subject from the light emitted by the light emitting means, an image-formation means for forming an image by focusing the light reflected from the image-acquisition area, a conversion means for converting the image formed by the image-formation means into an electric signal, and an operation means for detecting the change of the image and calculating the amount of the change using the electric signal. However, the amount of computations for determining the movement of the subject may be relatively large since the pointing device has to acquire and process the images of the subject.

### SUMMARY OF THE INVENTION

Therefore, an object of the present invention is to provide a reflective optical detecting device capable of accurate detection of a direction and speed of movement of an object and having a relatively low manufacturing cost.

Accordingly, a reflective optical detecting device of the present invention is for detecting movement of an object in a predetermined area. The reflective optical detecting device comprises a light emitting unit, at least two optical detectors, and a comparing unit. The light emitting unit is used for illuminating the predetermined area. The optical detectors are disposed at opposite sides of the light emitting unit, and each of the optical detectors is associated with a respective detection region within the predetermined area for generating an output signal in response to light reflected from the object and detected thereby. The comparing unit is coupled to the optical detectors for receiving the output signal from each of the optical detectors, and is operable to output a comparison result according to the output signal of each of the optical detectors. The comparison result is to be used for determining the movement of the object.

In one embodiment of this invention, the two optical detectors are aligned with the light emitting unit. In another embodiment of this invention, the reflective optical detecting device comprises four of the optical detectors. Preferably, two of the optical detectors are disposed at opposite first and second sides of the light emitting unit and are aligned with the light emitting unit in a first direction, and the other two of the optical detectors are disposed at opposite third and fourth sides of the light emitting unit and are aligned with the light emitting unit in a second direction that is substantially perpendicular to the first direction.

Preferably, the comparing unit is operable to compare the output signal of each of the optical detectors with a reference signal for outputting a respective time-related pulse signal corresponding to the output signal as the comparison result. The output signal of each of the optical detectors is a voltage output, and the reference signal is a reference voltage. In one embodiment, the comparing unit includes at least two comparators. Each of the comparators corresponds to and is coupled to one of the optical detectors for receiving the output signal therefrom, and is operable to compare the output signal of the corresponding one of the optical detectors with the reference signal for outputting the respective time-related pulse signal.

Preferably, the reflective optical detecting device further comprises at least two optical lenses. Each of the optical detectors has a light-receiving surface for receiving the light reflected from the object, and each of the optical lenses corresponds to one of the optical detectors and is disposed adjacent to the light-receiving surface of the corresponding one of the optical detectors.

Preferably, the light emitting unit includes a light source for emitting light, and an optical lens disposed adjacent to a light-emitting surface of the light source.

Preferably, the reflective optical detecting device further comprises a housing formed with a plurality of holes registered with the light emitting unit and the optical detectors, respectively.

According to another aspect of this invention, an electronic apparatus comprises the above-mentioned reflective optical detecting device, and a control unit coupled to the reflective optical detecting device for receiving the comparison result therefrom. The control unit is operable to determine the movement of the object according to the comparison result.

Preferably, the control unit is further operable to implement an operation according to the movement of the object determined thereby.

### BRIEF DESCRIPTION OF THE DRAWINGS

Other features and advantages of the present invention will become apparent in the following detailed description of the preferred embodiments with reference to the accompanying drawings, of which:

FIG. 1 is a block diagram illustrating the first preferred embodiment of a reflective optical detecting device installed in an electronic apparatus according to this invention;

FIG. 2 is a schematic side view illustrating the reflective optical detecting device of the first preferred embodiment for detecting movement of an object;

FIG. 3 is a schematic top view of the reflective optical detecting device;

FIG. 4 is a schematic top view of the reflective optical detecting device provided with a housing;

FIG. 5 illustrates a comparing unit of the reflective optical detecting device for processing signals from two optical detectors;

FIG. 6 is a schematic side view illustrating the second preferred embodiment of the reflective optical detecting device according to this invention;

FIG. 7 is a schematic side view illustrating the third preferred embodiment of the reflective optical detecting device according to this invention; and

FIG. 8 is a schematic top view illustrating the fourth preferred embodiment of the reflective optical detecting device according to this invention.

### DETAILED DESCRIPTION OF THE PREFERRED EMBODIMENTS

Before the present invention is described in greater detail, it should be noted that like elements are denoted by the same reference numerals throughout the disclosure.

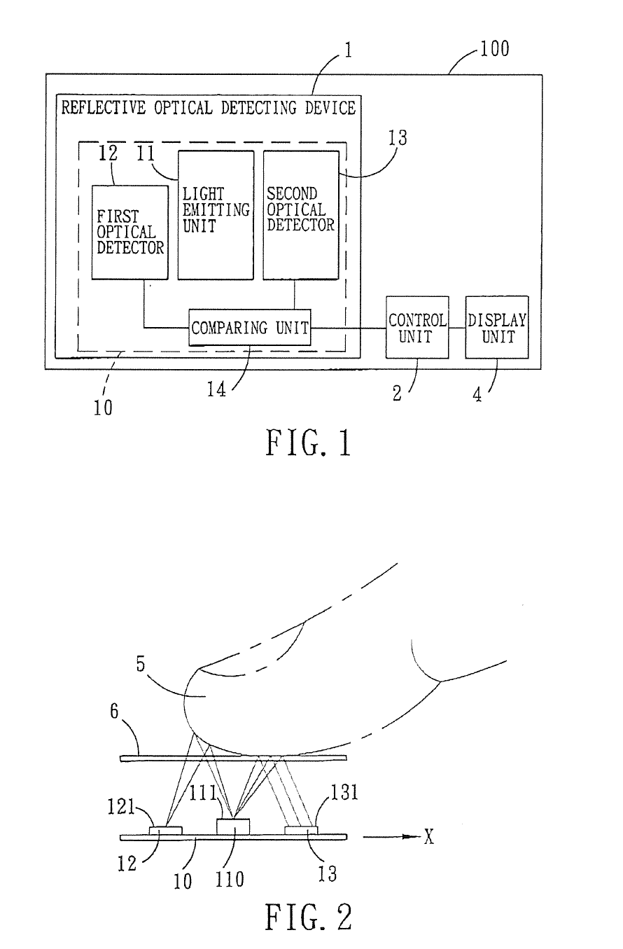

FIG. 1 illustrates the first preferred embodiment of a reflective optical detecting device 1 of this invention installed in an electronic apparatus 100. The electronic apparatus 100 includes display unit 4, and a control unit 2 coupled to the reflective optical detecting device 1 and the display unit 4. For example, the electronic apparatus 100 may be, but is not limited to, an electronic book reader, and the display unit 4 is a touch panel in this embodiment or a conventional liquid crystal display in other embodiments.

As shown in FIG. 2, the reflective optical detecting device 1 is used for detecting movement of an object 5 in a predetermined area. In this embodiment where the display unit 4 is a touch panel, the predetermined area is a specified area of a light-pervious plate 6 of the touch panel. In the case of the display unit 4 being a conventional liquid crystal display, the predetermined area is light-pervious area additionally configured on a surface of the conventional liquid crystal display.

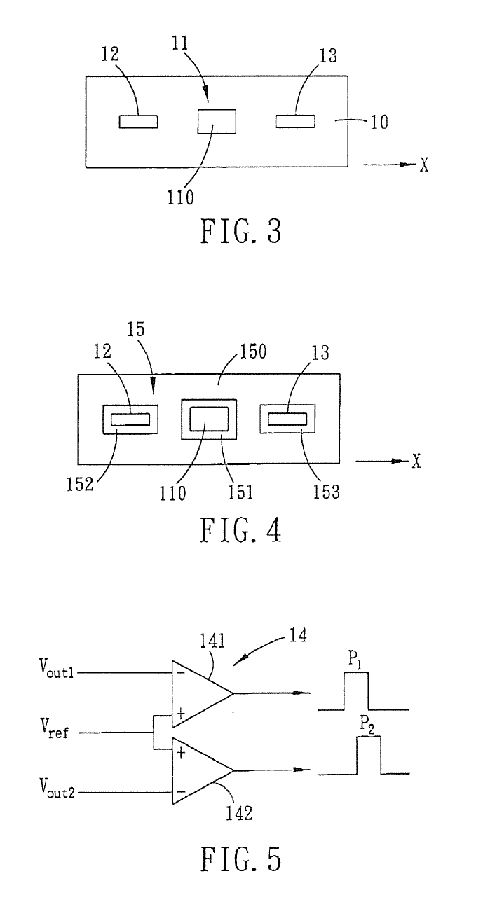

Referring to FIGS. 1 to 3, the reflective optical detecting device 1 of this embodiment includes a substrate 10, and a light emitting unit 11, a first optical detector 12, a second optical detector 13 and a comparing unit 14 that are disposed on the substrate 10. The light emitting unit 11 includes a light source 110 for emitting light to illuminate the predetermined area. The light emitted from the light source 110 may be visible light or non-visible light (such as infrared light). Each of the first and second optical detectors 12, 13 has a light-receiving surface 121, 131 for continuously detecting light reflected from the object 5, and is associated with a respective detection region within the predetermined area for generating an output signal in response to the light reflected from the object 5 and detected thereby. The comparing unit 14 is coupled to the first and second optical detectors 12, 13 for receiving the output signal from each of the first and second optical detectors 12, 13. The comparing unit 14 is operable to output a comparison result according to the output signal of each of the first and second optical detectors 12, 13. The control unit 2 is coupled to the comparing unit 14 of the reflective optical detecting device 1 for receiving the comparison result therefrom, and is operable to determine the movement of the object 5 according to the comparison result.

In this embodiment, the first and second optical detectors 12 and 13 are aligned with the light emitting unit 11. In particular, the first and second optical detectors 12 and 13 are disposed at opposite first and second sides of the light emitting unit 11 and are aligned with the light emitting unit 11 in a first direction (X) such that the configuration of the reflective optical detecting device 1 of this embodiment is suitable for detecting the movement of the object 5 in the first direction (X).

Referring to FIG. 4, the reflective optical detecting device 1 further includes a housing 15 covering the substrate 10 for protecting the circuitry on the substrate 10. The housing 15 includes a housing body 150 formed with a plurality of holes 151, 152, 153 registered with the light emitting unit 11, the first optical detector 12 and the second optical detector 13, respectively. The size of the hole 151 is bigger than an area of a light-emitting surface 111 of the light source 110 of the light emitting unit 11. The size of the hole 152 is bigger than an area of the light-receiving surface 121 of the first optical detector 12, and the size of the hole 153 is bigger than an area of the light-receiving surface 131 of the second optical detector 13. In practice, the holes 151, 152, 153 can be filled with a light transmissive medium, such as glass or transparent sealing resin.

Referring to FIGS. 1, 2 and 5, in this embodiment, the output signal of the first optical detector 12 is a first voltage output (Vₒᵤₜ₁), and the output signal of the second optical detector 13 is a second voltage output (Vₒᵤₜ₂). The comparing unit 14 includes two comparators 141 and 142, each of which corresponds to and is coupled to one of the first and second optical detectors 12, 13 for receiving the output signal (Vₒᵤₜ₁ and Vₒᵤₜ₂) therefrom. Each of the comparators 141, 142 is operable to compare the output signal (Vₒᵤₜ₁ and Vₒᵤₜ₂) of the corresponding one of the first and second optical detectors 12, 13 with a reference signal (V_{ref}) which is a reference voltage.

For example, when the object 5 moves to and covers the hole 152 at a first time point (t1), the object 5 reflects the light from the light source 110 to the first optical detector 12. Thus, a voltage of the output signal (Vₒᵤₜ₁) of the first optical detector 12 chances, and the comparator 191 of the comparing unit 19 is operable to compare the output signal (Vₒᵤₜ₁) with the reference signal (V_{ref}) for outputting a respective time-related pulse signal (P₁). Then, when the object 5 moves to and covers the hole 153 at a second time point (t2), the object 5 reflects the light to the second optical detector 13. Thus, the output signal (Vₒᵤₜ₂) of the second optical detector 13 changes, and the comparator 142 of the comparing unit 14 is operable to compare the output signal (Vₒᵤₜ₂) with the reference signal (V_{ref}) for outputting a respective time-related pulse signal (P₂).

Then, the control unit 2 is operable to receive the time-related pulse signals (P₁ and P₂) from the comparing unit 14 as the comparison result. Since the control unit 2 receives the time-related pulse signals (P₁ and P₂) at different time points (t1 and t2), the control unit 2 can determine the movement of the object 5 according to a time difference (t2−t1) between the first and second time points (t1 and t2) and the order of receipt of the time-related pulse signals (P₁ and P₂). The control unit 2 is operable to determine a velocity and a direction of the movement of the object 5 along the first direction (X), or to determine that the object 5 stays in the predetermined area or that there is no object in the predetermined area. For example, in the above-mentioned case that the first time point (t1) is earlier than the second time point (t2), the control unit 2 receives the time-related pulse signal (P₁) prior to receipt of the time-related pulse signal (P₂), and is operable to determine that the object 5 moves from left to right along the first direction (X). Then, the control unit 2 is further operable to implement an operation (e.g., turning to the next page in the case of the electronic book reader) according to the movement of the object 5 determined thereby.

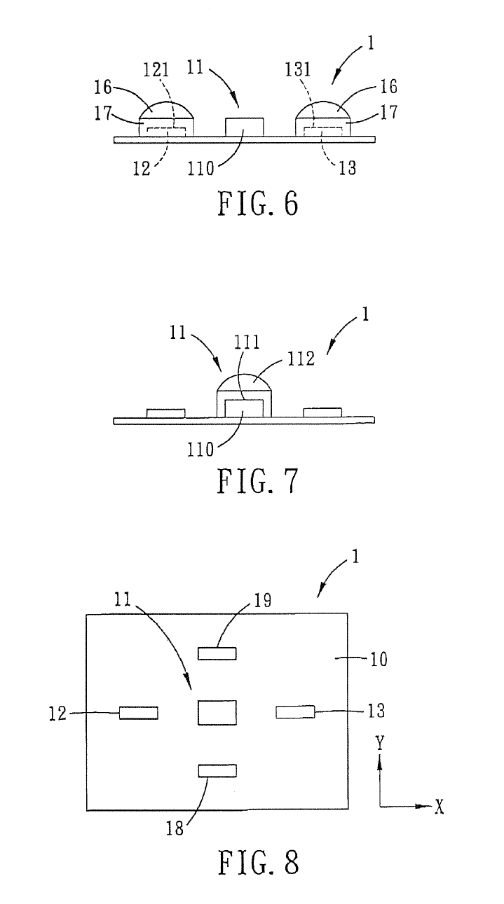

Referring to FIG. 6, the second preferred embodiment of a reflective optical detecting device 1 of this invention is shown to be similar to the first preferred embodiment. In the second preferred embodiment, the reflective optical detecting device 1 further includes two optical lenses 16 and two supporting frames 17 for supporting the optical lenses 16. Each of the optical lenses 16 corresponds to one of the first and second optical detectors 12, 13, and is supported adjacent to the light-receiving surface 121, 131 of the corresponding one of the first and second optical detectors 12, 13 by a corresponding one of the supporting frames 17, to thereby enhance the light-receiving efficiency of the first and second optical detectors 12, 13 and to limit undesired incident light for enhancing accuracy of detection.

Referring to FIG. 7, the third preferred embodiment of a reflective optical detecting device 1 of this invention is shown to be similar to the first preferred embodiment. In the third preferred embodiment, the light emitting unit 11 further includes an optical lens 112 disposed adjacent to the light-emitting surface 111 of the light source 110, to thereby condense the light emitted from the light source 110 onto the predetermined area.

Referring to FIG. 8, the fourth preferred embodiment of a reflective optical detecting device 1 of this invention is operable to detect two-dimensional movement of an object. In this embodiment, the reflective optical detecting device 1 further includes a third optical detector 18 and a fourth optical detector 19 that are disposed on the substrate 10. The third and fourth optical detectors 18, 19 are disposed at opposite third and fourth sides of the light emitting unit 11, and are aligned with the light emitting unit 11 in a second direction (Y) that is substantially perpendicular to the first direction (X). The configuration of the third and fourth optical detectors 18, 19 is similar to the configuration of the first and second optical detectors 12, 13. When the object (not shown) moves along the second direction (Y), the comparing unit 14 is operable to compare the output signal of each of the third and fourth optical detectors 18, 19 with the reference signal for outputting a respective time-related pulse signal corresponding to the output signal as the comparison result. Thus, the control unit 2 is operable to determine a velocity and a direction of the movement of the object along the second direction (Y), or to determine that the object stays in the predetermined area or that there is no object in the predetermined area. Then, the control unit 2 is further operable to implement an operation according to the movement of the object determined thereby.

In summary, the reflective optical detecting device 1 of this invention is operable to provide the comparison result to the control unit 2 of the electronic apparatus 100 for determining the movement of the object 5 by use of at least two optical detectors (12 and 13, or 18 and 19) and the comparing unit 14.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A reflective optical detecting device for detecting movement of an object in a predetermined area, said reflective optical detecting device comprising:
a light emitting unit for illuminating the predetermined area;
at least two optical detectors disposed at opposite sides of said light emitting unit, each of said optical detectors being associated with a respective detection region within the predetermined area for generating an output signal in response to light reflected from the object and detected thereby; and
a comparing unit coupled to said optical detectors for receiving the output signal from each of said optical detectors, said comparing unit being operable to output a comparison result according to the output signal of each of said optical detectors, the comparison result to be used for determining the movement of the object.

2. The reflective optical detecting device as claimed in claim 1, wherein said two optical detectors are aligned with said light emitting unit.

3. The reflective optical detecting device as claimed in claim 1, comprising four of said optical detectors,
wherein two of said optical detectors are disposed at opposite first and second sides of said light emitting unit and are aligned with said light emitting unit in a first direction, and the other two of said optical detectors are disposed at opposite third and fourth sides of said light emitting unit and are aligned with said light emitting unit in a second direction that is substantially perpendicular to the first direction.

4. The reflective optical detecting device as claimed in claim 1, wherein said comparing unit is operable to compare the output signal of each of said optical detectors with a reference signal for outputting a respective time-related pulse signal corresponding to the output signal as the comparison result.

5. The reflective optical detecting device as claimed in claim 4, wherein the output signal of each of said optical detectors is a voltage output, and the reference signal is a reference voltage.

6. The reflective optical detecting device as claimed in claim 4, wherein said comparing unit includes at least two comparators, each of which corresponds to and is coupled to one of said optical detectors for receiving the output signal therefrom, and is operable to compare the output signal of the corresponding one of said optical detectors with the reference signal for outputting the respective time-related pulse signal.

7. The reflective optical detecting device as claimed in claim 1, further comprising at least two optical lenses,
wherein each of said optical detectors has a light-receiving surface for receiving the light reflected from the object, and each of said optical lenses corresponds to one of said optical detectors and is disposed adjacent to said light-receiving surface of the corresponding one of said optical detectors.

8. The reflective optical detecting device as claimed in claim 1, wherein said light emitting unit includes a light source for emitting light, and an optical lens disposed adjacent to a light-emitting surface of said light source.

9. The reflective optical detecting device as claimed in claim 1, further comprising a housing formed with a plurality of holes registered with said light emitting unit and said optical detectors, respectively.

10. An electronic apparatus, comprising:
a reflective optical detecting device for detecting movement of an object in a predetermined area, said reflective optical detecting device including
a light emitting unit for illuminating the predetermined area,
at least two optical detectors disposed at opposite sides of said light emitting unit, each of said optical detectors being associated with a respective detection region within the predetermined area for generating an output signal in response to light reflected from the object and detected thereby, and
a comparing unit coupled to said optical detectors for receiving the output signal from each of said optical detectors, said comparing unit being operable to output a comparison result according to the output signal of each of said optical detectors; and
a control unit coupled to said reflective optical detecting device for receiving the comparison result therefrom, and operable to determine the movement of the object according to the comparison result.

11. The electronic apparatus as claimed in claim 10, wherein said two optical detectors are aligned with said light emitting unit.

12. The electronic apparatus as claimed in claim 10, wherein said reflective optical detecting device includes four of said optical detectors, two of said optical detectors are disposed at opposite first and second sides of said light emitting unit and are aligned with said light emitting unit in a first direction, and the other two of said optical detectors are disposed at opposite third and fourth sides of said light emitting unit and are aligned with said light emitting unit in a second direction that is substantially perpendicular to the first direction.

13. The electronic apparatus as claimed in claim 10, wherein said comparing unit is operable to compare the output signal of each of said optical detectors with a reference signal for outputting a respective time-related pulse signal corresponding to the output signal as the comparison result.

14. The electronic apparatus as claimed in claim 13, wherein the output signal of each of said optical detectors is a voltage output, and the reference signal is a reference voltage.

15. The electronic apparatus as claimed in claim 13, wherein said comparing unit includes at least two comparators, each of which corresponds to and is coupled to one of said optical detectors for receiving the output signal therefrom, and is operable to compare the output signal of the corresponding one of said optical detectors with the reference signal for outputting the respective time-related pulse signal.

16. The electronic apparatus as claimed in claim 10, wherein each of said optical detectors has a light-receiving surface for receiving the light reflected from the object, and said reflective optical detecting device further includes at least two optical lenses each corresponding to one of said optical detectors and being disposed adjacent to said light-receiving surface of the corresponding one of said optical detectors.

17. The electronic apparatus as claimed in claim 10, wherein said light emitting unit includes a light source for emitting light, and an optical lens disposed adjacent to a light-emitting surface of said light source.

18. The electronic apparatus as claimed in claim 10, wherein said reflective optical detecting device further includes a housing formed with a plurality of holes registered with said light emitting unit and said optical detectors, respectively.

19. The electronic apparatus as claimed in claim 10, wherein said control unit is further operable to implement an operation according to the movement of the object determined thereby.
